(19) United States
(12) Patent Application Publication
(10) Pub. No.: US 2026/0223943 A1
(43) Pub. Date: Aug. 6, 2026

(54) AUTHORIZATION FOR AN AEROSOL-GENERATING DEVICE

(71) Applicant: Philip Morris Products S.A., Neuchatel (CH)

(72) Inventor: Karim MARDAMBEY, Lausanne (CH)

(73) Assignee: Philip Morris Products S.A., Neuchatel (CH)

(21) Appl. No.: 19/121,866

(22) PCT Filed: Oct. 25, 2023
(86) PCT No.: PCT/EP2023/079800

§ 371 Date: Apr. 17, 2025

(30) Foreign Application Priority Data
Oct. 25, 2022 (EP) 22203484.5

(51) Int. Cl. A24F 40/49; A24F 40/53; G06F 21/32; G06V 10/82; G06V 40/16; G06V 40/50

(52) U.S. Cl. CPC A24F 40/49; A24F 40/53; G06F 21/32; G06V 10/82; G06V 40/172; G06V 40/178; G06V 40/50

(57) ABSTRACT

An aerosol-generating system is provided, including: an aerosol-generating device configured to generate, in an unlocked state, an aerosol from an aerosol-forming substrate; an image acquisition sensor configured to capture at least one image of a user of the aerosol-generating device; and at least one processor configured to: estimate, based on the at least one image of the user, an age of the user, determine whether the estimated age of the user is above a threshold or equal to the threshold, and unlock the aerosol-generating device when the estimated age is above the threshold or equal to the threshold.

The present disclosure relates to an aerosol-generating system. In particular, the disclosure relates to a system for unlocking an aerosol-generating device.

An aerosol-generating device may comprise an electrically operated heat source that is configured to heat an aerosol-forming substrate to produce an aerosol, such as a nicotine-containing aerosol. However, such electronic devices should not be accessed by unauthorized users. Accordingly, there is a need for a system that would enable only authorized users to access the electronic device.

A user may be authorized to use an aerosol-generating device when the user's age is above a legal minimum age. Legal requirements may require that the age of the user is verified. The age of the user may be verified by selling the aerosol-generating device only to users that are old enough. For example, an identity of a user may be checked based on an identity card and the age may be verified based on the identity card. However, such age verification mechanisms are open to attempts at fraud, particularly when an identity card is uploaded via an online platform rather than being checked physically in the presence of the presented owner of the identity card. In addition, such systems for verifying the age of the user may be inefficient or error-prone. Furthermore, some commercially available aerosol-generating devices can be used if stolen by an unauthorized person, where that unauthorized person's age cannot be verified. Accordingly, there is a need for an efficient and reliable method for verifying an authorization of a user for using an aerosol-generating device.

According to an aspect of the present invention, there is provided an aerosol-generating system, comprising an aerosol-generating device configured to generate, in an unlocked state, an aerosol from an aerosol-forming substrate, an image acquisition sensor configured to capture at least one image of a user of the aerosol-generating device, and at least one processor configured to estimate, based on the at least one image of the user, an age of the user, determine whether the estimated age of the user is above or equal to a threshold, and unlock the aerosol-generating device when the estimated age is above or equal to the threshold.

By estimating an age of the user based on at least one image of the user for unlocking an aerosol-generating device, an improved aerosol-generating system is provided for granting access to the aerosol-generating device in a reliable and efficient manner. Specifically, an aerosol-generating system comprising an image acquisition sensor and estimating an age of the user based on an image allows the restriction of access to the aerosol-generating device to only authorized users. The aerosol-generating device may be in one of at least two states, such as a locked state and an unlocked state. The aerosol-generating device can be transitioned from a locked state to an unlocked state. Alternatively or additionally, the aerosol-generating device can be transitioned from the unlocked state to the locked state. The “locked state” may be a state in which the aerosol-generating device is prevented from generating or configured to not generate an aerosol from an aerosol-forming substrate. The “unlocked state” may be a state in which the aerosol-generating device is configured to generate an aerosol from the aerosol-forming substrate.

The step of determining whether the estimated age of the user is above or equal to a threshold may comprise at least one of: outputting an estimated age range of the user; outputting an estimated youngest age and optionally an estimated oldest age of the user; determining that the estimated age of the user is above or equal to the threshold, if the estimated youngest age is above or equal to the threshold; and determining an accuracy score indicative of the accuracy of the estimate of the age of the user. The aerosol-generating device may only be unlocked, if the accuracy score is above or equal to an accuracy threshold.

Furthermore, the aerosol-generating system may comprise a microphone configured to record a voice of the user, and the at least one processor may be configured to estimate the age of the user based on the at least one image of the user and the recorded voice of the user.

By estimating the age of the user based on the at least one image of the user and the recorded voice of the user, an improved system for granting access to only authorized users using multiple levels of authorization is provided. The at least one image of the user may be at least one image of the user's face. The at least one image of the user may be a self-portrait photograph, such as a selfie. The at least one image of the user may be captured in accordance with instructions presented to the user, such as at least one of a distance of the user to the image acquisition sensor, a position of the user or the head of the user in the at least one image, and or an orientation of the user or the head of the user. The area of an image of the at least one image defining the user's face may be at least 10%, 20%, 30%, 40%, 50%, 60%, 70% of the total area of the image. The at least one image may be captured within 1 hour, 2 hour, 6 hours, 12 hours, 24 hours of the determination whether the estimated age of the user is above or equal to a threshold.

The aerosol-generating system may comprise a mobile computing device of the user, which comprises the image acquisition sensor. The mobile computing device of the user may be remote from the aerosol-generating device. The at least one processor may be configured to convert the at least one image of the user into at least one corresponding anonymized pixel map at the mobile computing device, and send the anonymized pixel map from the mobile computing device to a server, and the age of the user is estimated based on the anonymized pixel map at the server. The step of converting the at least one image of the user into at least one corresponding anonymized pixel map may comprise at least one of: blurring one or more portions of the at least one image (e.g. images of the at least one image and/or portions of images comprising a face); pixelation (e.g. lowering the resolution) of one or more portions of the at least one image (e.g. those portions comprising an image of a face); obscuring (e.g. replacing with solid color) one or more portions of the at least one image (e.g. those portions comprising an image of a face). The at least one image of the user may be converted into at least one corresponding pixel map, such that the identity of the user is not determinable from the pixel map. The at least one image of the user may be converted into at least one corresponding anonymized pixel map by using at least one neural network, such as a generative adversarial network. The at least one neural network may be used to retrieve information about the users age from the anonymized pixel map. The anonymized pixel map may be a feature map of the at least one neural network. The feature map may be obtained from a layer of the at least one neural network, such as a deep convolutional neural network. The layer may be in the middle of the at least one neural network and/or not a layer at the edge, such as a first or last layer, of the at least one neural network.

At least one of the at least one image of the user and the anonymized pixel map may be deleted after determining the estimated age of the user and/or unlocking the aerosol-generating device. Only the anonymized pixel map may be sent to the server. The at least one image of the user may not be sent to the server. The at least one image of the user may be deleted after the anonymized pixel map is generated or the at least one image of the user is converted into the at least one corresponding anonymized pixel map.

By sending an anonymized pixel map from the mobile computing device to a server and/or by deleting at least one of the at least one image of the user and the anonymized pixel map, personal data can be protected.

The at least one image of the user may be verified for being authentic by at least one of determining whether the at least one image of the user has been tampered with, by analyzing the at least one image of the user using a neural network for recognizing presentation attacks, determining that a detected sound of the user corresponds to the at least one image of the user, and determining a muscle movement of the user in at least two of the at least one image of the user.

According to another aspect of the present invention, there is provided a computer-implemented method of unlocking an aerosol-generating device comprising obtaining at least one image of a user of an aerosol-generating device, estimating, based on the at least one image of the user, an age of the user, determining whether the estimated age of the user is above a threshold, and unlocking, when the estimated age is determined to be above the threshold, the aerosol-generating device for generating an aerosol from an aerosol-forming substrate.

By unlocking an aerosol-generating device for generating an aerosol from an aerosol-forming substrate, when an estimated age is determined to be above a threshold, an improved method is provided that provides for authentication of an age of a user via an image acquisition sensor.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-forming substrate disposed in and/or engaged with the aerosol-generating device” refers to the combination of an aerosol-generating device with an aerosol-forming substrate. When the aerosol-forming substrate forms part of an aerosol-generating article, the aerosol-forming substrate disposed in and/or engaged with the aerosol-generating device refers to the combination of the aerosol-generating device with the aerosol-generating article. The aerosol-forming substrate and the aerosol-generating device may cooperate to generate an aerosol.

As used herein, the term “aerosol-forming substrate” refers to a substrate capable of releasing volatile compounds that can form an aerosol. The volatile compounds may be released by heating the aerosol-forming substrate. As an alternative to heating, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. The aerosol may comprise nicotine. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

The invention is defined in the claims. However, a non-exhaustive list of non-limiting examples is provided below. Any one or more of the features of these examples may be combined with any one or more features of another example, embodiment, or aspect described herein.

Example Ex1: An aerosol-generating system, comprising an aerosol-generating device configured to generate, in an unlocked state, an aerosol from an aerosol-forming substrate, an image acquisition sensor configured to capture at least one image of a user of the aerosol-generating device, and at least one processor configured to estimate, based on the at least one image of the user, an age of the user, determine whether the estimated age of the user is above or equal to a threshold, and unlock the aerosol-generating device when the estimated age is above a threshold.

Example Ex2: The aerosol-generating system according to example Ex1, comprising a microphone configured to record a voice of the user, wherein the at least one processor is configured to estimate the age of the user based on the at least one image of the user and the recorded voice of the user.

Example Ex3: The aerosol-generating system according to one of examples Ex1 and Ex2, comprising a mobile computing device of the user, wherein the mobile computing device comprises the image acquisition sensor.

Example Ex4: The aerosol-generating system according to example Ex3, wherein the at least one processor is configured to convert the at least one image of the user into at least one corresponding anonymized pixel map at the mobile computing device, and send the anonymized pixel map from the mobile computing device to a server, wherein the age of the user is estimated based on the anonymized pixel map at the server.

Example Ex5: The aerosol-generating system according to example Ex4, wherein the at least one processor is configured to delete at least one of the at least one image of the user and the anonymized pixel map after determining the estimated age of the user and/or unlocking the aerosol-generating device.

Example Ex6: The aerosol-generating system according to one of examples Ex1 to Ex5, wherein the age of the user is estimated by using a machine-learning model, for instance a neural network, preferably a deep neural network.

Example Ex7: The aerosol-generating system according to one of examples Ex1 to Ex6, wherein the at least one processor is configured to verify that the at least one image of the user is authentic by at least one of: determining whether the at least one image of the user has been tampered with, by analyzing the at least one image of the user using a neural network for recognizing presentation attacks, determining that a detected sound of the user corresponds to the at least one image of the user, and determining a muscle movement of the user in at least two of the at least one image of the user.

Example Ex8: The aerosol-generating system according to one of examples Ex1 to Ex7, wherein the threshold is predefined, preferably by a manufacturer of the aerosol-generating device.

Example Ex9: The aerosol-generating system according to one of examples Ex1 to Ex8, wherein the threshold is at least N years above a first age, the first age being set for authorizing usage of the aerosol-generating device, preferably wherein N =1 or more, 2 or more, 3 or more, 4 or more, or 5 or more, or
wherein the threshold is a first age threshold, and the first age threshold is one of:
18 years or more,
19 years or more,
20 years or more,
25 years or more, and
30 years or more.

Example Ex10: The aerosol-generating system according to one of examples Ex1 to Ex9, wherein the at least one processor is configured to determine a user profile of the user based on the at least one image of the user, and optionally wherein the aerosol-generating device is configured in accordance with the user profile.

Example Ex11: The aerosol-generating system according to one of examples Ex1 to Ex10, wherein the at least one processor is configured to verify an identity of the user based on the at least one image of the user.

Example Ex12: The aerosol-generating system according to one of examples Ex1 to Ex11, further comprising an aerosol-generating article comprising the aerosol-generating substrate.

Example Ex13: The aerosol-generating system according to example Ex12, wherein the aerosol-generating substrate comprises nicotine.

Example Ex14: The aerosol-generating system according to one of examples Ex12 and Ex13, wherein the aerosol-generating device is configured to receive the aerosol-generating substrate completely or partially and/or wherein a surface of the aerosol-generating device is configured to be attached to the aerosol-generating substrate.

Example Ex15: The aerosol-generating system according to one of examples Ex1 to Ex14, wherein the aerosol-generating device is configured to be in one of a locked state and an unlocked state.

Example Ex16: The aerosol-generating system according to example Ex15, wherein the locked state is a state in which the aerosol-generating device is prevented from generating an aerosol from an aerosol-forming substrate.

Example Ex17: The aerosol-generating system according to example Ex15 or example Ex16, wherein unlocking the aerosol-generating device when the estimated age is above a threshold comprises instructing the aerosol-generating device to transition from a locked state to an unlocked state.

Example Ex18: The aerosol-generating system according to one of examples Ex1 to Ex17, wherein the determining whether the estimated age of the user is above or equal to a threshold comprises outputting an estimated age range of the user.

Example Ex19: The aerosol-generating system according to one of examples Ex1 to Ex18, wherein the determining whether the estimated age of the user is above or equal to a threshold comprises outputting an estimated youngest age.

Example Ex20: The aerosol-generating system according to one of examples Ex1 to Ex19, wherein the determining whether the estimated age of the user is above or equal to a threshold comprises outputting an estimated oldest age of the user.

Example Ex21: The aerosol-generating system according to example Ex19, wherein the determining whether the estimated age of the user is above or equal to a threshold comprises determining that the estimated age of the user is above or equal to the threshold, if the estimated youngest age is above or equal to the threshold.

Example Ex22: The aerosol-generating system according to one of examples Ex1 to Ex21, wherein the determining whether the estimated age of the user is above or equal to a threshold comprises determining an accuracy score indicative of an accuracy of the estimate of the age of the user.

Example Ex23: The aerosol-generating system according to example Ex22, wherein the aerosol-generating device remains locked, when the accuracy score is below an accuracy threshold.

Example Ex24: The aerosol-generating system according to example Ex22, wherein the aerosol-generating device is only unlocked, if the accuracy score is above or equal to an accuracy threshold.

Example Ex25: The aerosol-generating system according to one of examples Ex1 to Ex24, wherein the at least one image of the user comprises at least one image of the user's face.

Example Ex26: The aerosol-generating system according to one of examples Ex1 to Ex24, wherein the at least one image of the user comprises a self-portrait photograph.

Example Ex27: The aerosol-generating system according to one of examples Ex1 to Ex26, wherein the at least one image of the user is captured in accordance with instructions presented to the user.

Example Ex28: The aerosol-generating system according to example Ex27, wherein the instructions presented to the user comprise a distance for the user to the image acquisition sensor.

Example Ex29: The aerosol-generating system according to one of examples Ex27 and Ex28, wherein the instructions presented to the user comprise a position of the user or the head of the user in the at least one image.

Example Ex30: The aerosol-generating system according to one of examples Ex27 to Ex29, wherein the instructions presented to the user comprise an orientation of the user or the head of the user.

Example Ex31: The aerosol-generating system according to one of examples Ex1 to Ex30, wherein an area of an image of the at least one image defining the user's face is at least 10%, 20%, 30%, 40%, 50%, 60%, 70% of the total area of the image.

Example Ex32: The aerosol-generating system according to one of examples Ex1 to Ex31, wherein the at least one image is captured within a 1 hour, 2 hour, 6 hour, 12 hour, or 24 hour time period prior to the determination whether the estimated age of the user is above or equal to a threshold.

Example Ex33: The aerosol-generating system according to example Ex3 or any prior example including example Ex3, wherein the mobile computing device of the user is remote from the aerosol-generating device.

Example Ex34: The aerosol-generating system according to example Ex4 or any prior example including example Ex4, wherein the step of converting the at least one image of the user into at least one corresponding anonymized pixel map comprises blurring one or more portions of the at least one image.

Example Ex35: The aerosol-generating system according to example Ex4 or any prior example including example Ex4, wherein the step of converting the at least one image of the user into at least one corresponding anonymized pixel map comprises lowering the resolution of one or more portions of the at least one image.

Example Ex36: The aerosol-generating system according to example Ex4 or any prior example including example Ex4, wherein the step of converting the at least one image of the user into at least one corresponding anonymized pixel map comprises obscuring one or more portions of the at least one image.

Example Ex37: The aerosol-generating system according to one of examples Ex34 to Ex36, wherein the one or more portions of the at least one image comprise a face or an image of a face of the user.

Example Ex38: The aerosol-generating system according to example Ex4 or any prior example including example Ex4, wherein an identity of the user is not determinable from the at least on pixel map.

Example Ex39: The aerosol-generating system according to example Ex4 or any prior example including example Ex4, wherein the at least one image of the user is converted into at least one corresponding anonymized pixel map by using at least one neural network.

Example Ex40: The aerosol-generating system according to example Ex39, wherein the at least one neural network is used to retrieve information about the users age from the anonymized pixel map.

Example Ex41: The aerosol-generating system according to example Ex4 or any prior example including example Ex4, wherein the anonymized pixel map comprises a feature map of at least one neural network.

Example Ex42: The aerosol-generating system according to example Ex41, wherein the feature map is obtained from a layer of the at least one neural network.

Example Ex43: The aerosol-generating system according to example Ex42, wherein the layer is not a layer at the edge of the at least one neural network.

Example Ex44: The aerosol-generating system according to one of examples Ex41 to Ex43, wherein the feature map is obtained comprising a convolution operation of the at least one neural network.

Example Ex45: The aerosol-generating system according to example Ex4 or any prior example including example Ex4, wherein only the anonymized pixel map is sent to the server.

Example Ex46: The aerosol-generating system according to example Ex4 or any prior example including example Ex4, wherein the at least one image of the user is deleted after the at least one image of the user is converted into the at least one corresponding anonymized pixel map.

Example Ex47: A computer-implemented method of unlocking an aerosol-generating device, the method comprising: obtaining at least one image of a user of an aerosol-generating device, estimating, based on the at least one image of the user, an age of the user, determining whether the estimated age of the user is above a threshold, and unlocking, when the estimated age is determined to be above the threshold, the aerosol-generating device for generating an aerosol from an aerosol-forming substrate.

Example Ex48: The computer-implemented method according to example Ex47, further comprising obtaining voice data of the user, wherein the age of the user is estimated based on the at least one image of the user and the obtained voice data of the user.

Example Ex49: The computer-implemented method according to one of examples Ex47 and Ex48, further comprising: converting the at least one image of the user into at least one corresponding anonymized pixel map, and send the anonymized pixel map to a server for estimating the age of the user, wherein the age of the user is estimated based on the anonymized pixel map at the server.

Example Ex50: The computer-implemented method according to one of examples Ex47 to Ex49, further comprising: verifying that the at least one image of the user depicts a living human by at least one of: determining whether the at least one image of the user has been tampered with, by analyzing the at least one image of the user using a neural network for recognizing presentation attacks, determining that a detected sound of the user corresponds to the at least one image of the user, and determining a muscle movement of the user in at least two of the at least one image of the user.

Examples will now be further described with reference to the figures in which:

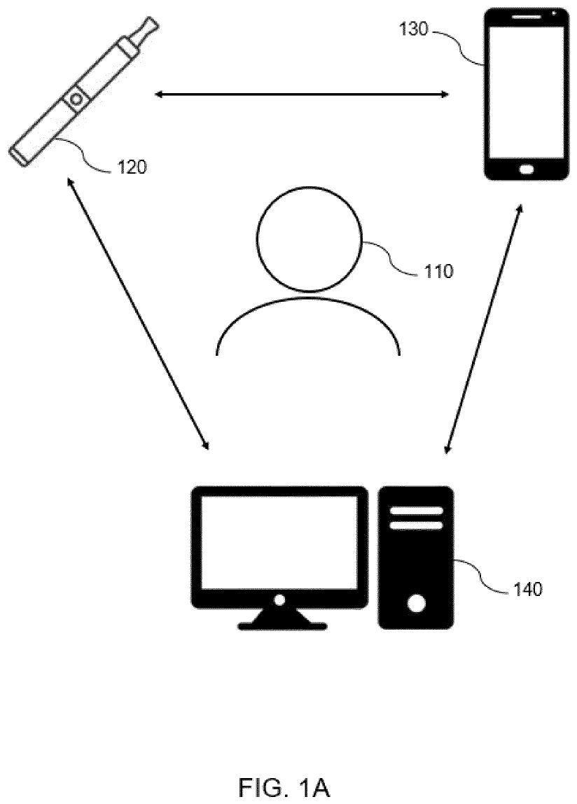

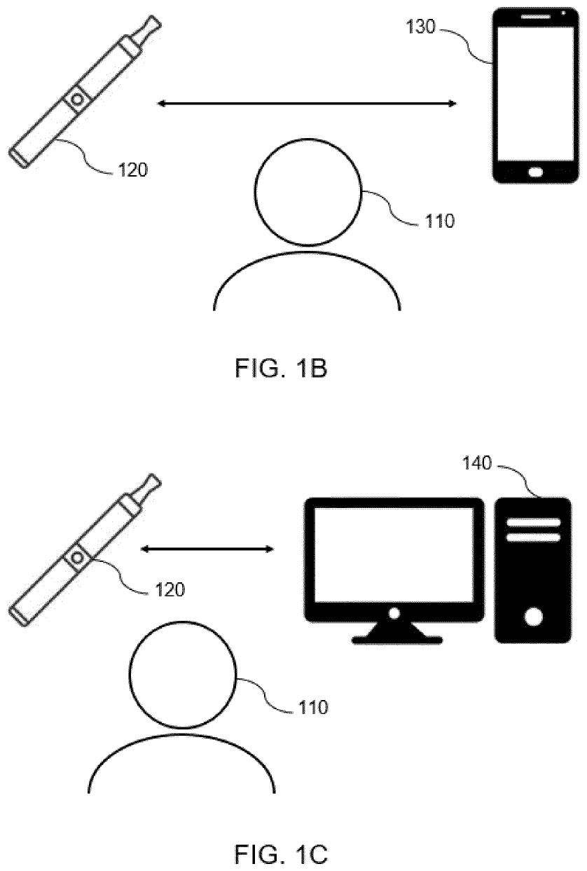

FIG. 1A shows a schematic illustration of an aerosol-generating system according to an aspect;

FIG. 1B shows a schematic illustration of an aerosol-generating system according to an aspect;

FIG. 1C shows a schematic illustration of an aerosol-generating system according to an aspect; and

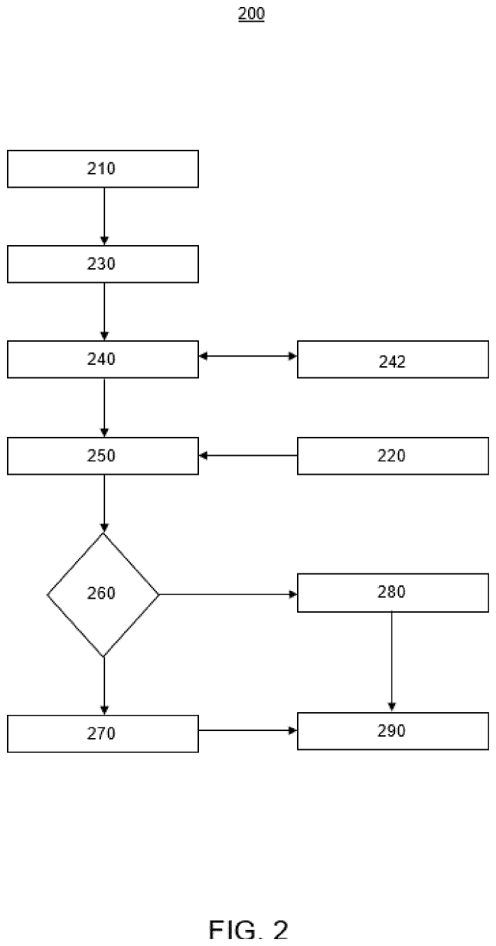

FIG. 2 is a flow diagram showing a method of unlocking an aerosol-generating device.

FIG. 1A illustrates an aerosol-generating system 100. The aerosol-generating system comprises an aerosol-generating device 120 configured to generate an aerosol from an aerosol-forming substrate. The aerosol-generating device 120 may be a heat-not-burn (HNB) device. The aerosol-generating system 100 may be used to unlock the aerosol-generating device 120 for usage by a user 110. The aerosol-forming substrate may be disposed in and/or engaged with the aerosol-generating device 100. Alternatively, the aerosol-forming substrate (e.g. a liquid in a cartridge) may be attached to the aerosol-generating device 120. The aerosol-generating system comprises an image acquisition sensor 130 configured to capture at least one image of a user 110.

The image acquisition sensor may be comprised in the aerosol-generating device 120. Alternatively, the image acquisition sensor may be remote from the aerosol-generating device 120. For example, the image acquisition sensor may be part of a computing device 130, such as a mobile computing device, e.g. a smartphone. The computing device 130 and the aerosol-generating device 120 may be connected via a first network. The first network may be a wireless network, such as a Bluetooth network.

The aerosol-generating system 100 may comprise a server 140. The server 140 may be connected to at least one of the aerosol-generating device 120 and the computing device 130 via a second network. The second network may be a wireless network, such as a WiFi network.

The image acquisition sensor may be configured to capture an image or a plurality of images of the user 110. The image acquisition sensor may be configured to capture depth information or a plurality of depth values of the user from a single viewpoint or a plurality of viewpoints. Examples of the image acquisition sensor may include a LIDAR (Light Detection and Ranging) sensor, a wide-angle camera, an action camera, a closed-circuit television (CCTV) camera, a camcorder, a digital camera, camera phones, a time-of-flight (ToF) camera, a night-vision camera, an image sensor, and/or other image capturing devices.

The at least one captured image may be transmitted to the server 140. Alternatively, the at least one captured image may be converted into at least one corresponding anonymized pixel map and the at least one anonymized pixel map may be sent to the server 140. The at least one captured image may be converted into at least one corresponding anonymized pixel map at the aerosol-generating device 120 or the computing device 130 and the at least one anonymized pixel map may be sent from the aerosol-generating device 120 or the computing device 130 to the server 140.

The age of the user may be estimated based on the at least one captured image or the anonymized pixel map at the server 140. The age of the user may be estimated by means of a machine-learning model, such as a neural network. The neural network may be a deep neural network.

Whether the estimated age of the user is above or equal to a threshold may be determined by at least one of the aerosol-generating device 120, the computing device 130 and the server 140. When the estimated age is above a threshold, the aerosol-generating device is transitioned from a locked state to an unlocked state. The “locked state” may be a state in which the aerosol-generating device is prohibited to generate aerosol.

In an example, the determination of whether the age is above the threshold is made at the server 140 or the computing device 130, and the computing device 130 sends a signal to unlock the aerosol-generating device 120. The aerosol-generating device 120 may be in a first state, such as a locked state in which the aerosol-generating device 120 is prohibited or prevented from generating aerosol. The signal from the computing device 130 may instruct the aerosol-generating device to switch or transition from the locked state to an unlocked state. For example, the aerosol-generating device 120 may be sold or purchased in a locked state, where the aerosol-generating device 120 cannot generate an aerosol. Only after transitioning to an unlocked state, the aerosol-generating device 120 may generate an aerosol from an aerosol-forming substrate.

The threshold may be predefined or selected by a manufacturer of the aerosol-generating device. The threshold may be at least N years above a first age (or a first age threshold). The threshold may be set for authorizing usage of the aerosol-generating device, where N=1 or more, 2 or more, 3 or more, 4 or more, or 5 or more. The first age threshold may be one of: 18 years or more, 19 years or more, 20 years or more, 21 years or more, 25 years or more and 30 years or more.

At least one of the aerosol-generating device 120 and the computing device 130 may comprise a microphone configured to record a voice or sound of the user 110. The server 140 may be configured to estimate the age of the user based on the at least one image of the user and the recorded voice or sound of the user 110.

At least one of the aerosol-generating device 120, the computing device 130 and the server 140 may be configured to verify that the at least one image of the user is authentic or depicts a living human. For example, the at least one of the aerosol-generating device 120, the computing device 130 and the server 140 may at least one of: (i) determine whether the at least one image of the user has been tampered with, by analyzing the at least one image of the user using a neural network for recognizing presentation attacks, (ii) determine that a detected sound of the user corresponds to the at least one image of the user, and (iii) determine a muscle movement of the user in at least two of the at least one image of the user to verify that the at least one image of the user is authentic.

To protect personal information of the user 110, at least one of the at least one image of the user and the anonymized pixel map may be deleted after determining the estimated age of the user and/or unlocking the aerosol-generating device at the server 140 and/or at the computing device 130.

According to one aspect, a user profile of the user is determined based on the at least one image of the user 110. The aerosol-generating device 120 may be configured in accordance with the user profile. In an example, the user profile may comprise information about an increased substance content, such as a nicotine content, compared to a different substance content, such as a flavor content, of a consumable, e.g. an aerosol-forming substrate, disposed in and/or engaged with the aerosol-generating device. Additionally or alternatively, an identity of the user 110 may be verified based on the at least one image of the user.

The aerosol-generating system 100 may be configured to unlock the aerosol-generating device 120. Unlocking the aerosol-generating device 120 may comprise setting the aerosol-generating device 120 to a state in which the aerosol-generating device 120 is configured to generate an aerosol from an aerosol-forming substrate in response to a user action.

In FIG. 1B, the aerosol-generating system comprises only the aerosol-generating device 120 and the computing device 130. The computing device 130 may be configured to perform the same action as the server of FIG. 1A. Additionally, the computing device 130 may be configured to perform all actions performed by the server in FIG. 1A.

For example, the user may connect the mobile computing device 130 with the aerosol-generating device 120 via a network, such as a wireless network. After connecting the devices 120 and 130, the user 110 may take a picture with the computing device 130 of the user 110. The computing device 130 may be configured to estimate, based on the picture of the user 110, an age of the user 110. The computing device 130 may be configured to determine whether the estimated age of the user 110 is above or equal to a threshold. When the estimated age is above a threshold, the computing device may instruct the aerosol-generating device 120 to unlock itself. In an example, the aerosol-generating system comprises a smart device (for example a smartphone) and the aerosol-generating device. The aerosol-generating device may be locked when it is sold. In order to unlock it, the user uses the smartphone. The smartphone may be configured to scan the user's face. Once the smartphone estimates the age based on the scan of the face, the aerosol-generating device may be automatically unlocked, when the estimated age is above a certain threshold.

In an example, a user, e.g. a consumer, of the aerosol-generating device takes a ‘selfie’ image using a mobile phone or desktop camera and submits the image together with consent that the image can be used to verify the user's age. A pixel map of the user's image, comprising a face of the user, may be generated. The pixel map may comprise information of the user's image in an anonymized manner. By using artificial intelligence (AI) models, an age estimation for the user's image may be provided. Immediately after the processing of the user's image is completed, any image data related to the user's image may be deleted. The solution immediately ‘forgets’ any face submitted. The estimated age may be returned to the mobile phone or a computing device and compared to a threshold, which may be determined and/or configured by a manufacturer of the aerosol-generating device. The system may not receive, process or store any biometric data of the user, nor any personal data or identity attributes of the user (e.g. first names and last names, address, date of birth).

To minimize the risk of allowing users with an age under a statutory age access to restricted content, such as using the aerosol-generating device, the threshold may be configured or set one or more years above the statutory age. Only users with an estimated age equal or above the threshold may gain access to the restricted content. The threshold may be set to 1 or more, 2 or more, 3 or more, 4 or more, 5 or more years above a statutory age for access to the restricted content to reduce the risk of false positives and improve the overall effectiveness of the solution. In FIG. 1C, the aerosol-generating system comprises only the aerosol-generating device 120 and the server 140. The aerosol-generating device 120 may be configured to perform the same action or at least some actions as the computing device 130 of FIG. 1A. In an aspect, the aerosol-generating device 120 may be configured to perform all actions performed by the computing device 130 and the server 140 in FIG. 1A.

For example, the aerosol-generating device 120 may comprise an image acquisition sensor configured to capture at least one image of the user 110 of the aerosol-generating device 120. The at least one image of the user 110 or at least one anonymized pixel map, which is based on the at least one image of the user 110, may be transmitted to the server 140. The server 140 may be configured to estimate, based on the at least one image of the user 110 or the anonymized pixel map, an age of the user, determine whether the estimated age of the user is above or equal to a threshold, and instruct the aerosol-generating device 120 to unlock the aerosol-generating device 120 when the estimated age is above a threshold.

In an example, at least one of the aerosol-generating device 120, the computing device 130 and the server 140 may include an inbuilt neural-network-based processor that is configured to communicate with a device comprising the image acquisition sensor for basic interactions associated with the image acquisition sensor. The neural network may include electronic data, such as, for example, a software program, code of the software program, libraries, applications, scripts, or other logic or instructions for execution by a processing device, such as the at least one of the aerosol-generating device 120, the computing device 130 and the server 140. The neural network may include code and routines configured to enable a computing device, such as the at least one of the aerosol-generating device 120, the computing device 130 and the server 140 to perform one or more operations for classification of one or more inputs. Further, the neural network may also be implemented using hardware including a processor, a microprocessor (e.g., to perform or control performance of one or more operations), a field-programmable gate array (FPGA), or an application-specific integrated circuit (ASIC). Alternatively, in some aspects, the neural network may be implemented using a combination of hardware and software.

In another example, the aerosol-generating device 120 is configured to interact with a smartphone for advanced interactions associated with the image acquisition sensor. For example, the image acquisition sensor may be comprised in a smartphone or other handheld computing device and the smartphone may be configured to process the images obtained from the image acquisition sensor. The smartphone may be configured to determine, based on at least one image of the user, at least one of an age and an identity of the user 110. The at least one of an age and an identity of the user 110 may be transmitted to the aerosol-generating device 120 for further processing. Alternatively, the smartphone may be configured to receive further information, such as information about a sound or voice of the user, for further processing. Results of such further processing may be transmitted to the aerosol-generating device 120 for unlocking the aerosol-generating device 120. In one aspect, the smartphone obtains the at least one image of the user and transmits the at least one image of the user to the aerosol-generating device 130 for further processing.

An acoustic sensor, such as a microphone may be configured to capture an audio signal of the user. The acoustic sensor may further be configured to convert the captured audio signal into an electrical signal to determine the age of the user. For example, the age of the user may be determined by analyzing an audio signal that comprises information about the user's voice.

The captured audio signal may include a plurality of voice parameters, such as a loudness parameter, an intonation parameter, an intensity of overtones, a voice modulation parameter, a pitch parameter, a tone parameter, a rate-of-speech parameter, a voice quality parameter, a phonetic parameter, a pronunciation parameter, a prosody parameter, a timbre parameter, and one or more psychoacoustic parameters, which may be converted into the electrical signal to determine the age of the user. Examples of the acoustic sensor may include a recorder, an electric microphone, a dynamic microphone, a carbon microphone, a piezoelectric microphone, a fiber microphone, a (micro-electro-mechanical-systems) MEMS microphone, or other microphones known in the art.

In operation, the aerosol-generating device may compare information associated with the one or more captured images, such as an estimated age, with information set by a manufacturer of the aerosol-generating device 120, such as a statutory age or a first age for usage of the aerosol-generating device 120. The information set by a manufacturer may be integrally stored in the aerosol-generating device 120 or remotely retrieved from a server 140 (for example, a cloud server) or a smartphone, via a suitable communication network (for example, via a Wireless Fidelity (Wi-Fi) network).

In an example, the image acquisition sensor may capture a one or more images of a first user 110. The aerosol-generating system 100 may estimate an age of the first user based on the captured images. Based on the estimated age, if the first user 110 (such as a child) is not an authorized user, the aerosol-generating device 120 may be maintained in a locked state, locked and/or turned off to prevent usage from the unauthorized user. The aerosol-generating system 100 may also generate an alert. For example, the alert may be provided to a second user or a device or service associated with the aerosol-generating device 120, such as a service of the manufacturer of the aerosol-generating device 120. The alert may comprise information about the unauthorized user of the aerosol-generating device. The alert may include information associated with an unauthorized user attempt on the aerosol-generating device. The alert may include at least one of an audible alert, a visual alert, an audio-visual alert, or a vibratory alert.

In response to the determination that the user is not verified or authorized to use the aerosol-generating device 120, the user 110 may be prompted to verify an age of the user 110 by means of an identity card. The image acquisition sensor may be configured to capture at least one image of the identity card. An identity of the user corresponding to the identity of the identity card may be verified based on an image of the user or an anonymized pixel map of the image of the user and an image of the identity card or an anonymized pixel map of the image of the identity card.

In another example, based on the determined features, if the captured images indicate that the authorized user is tired, drunk, stressed, or emotionally unstable, such that the user is in a sad, crying, or scared condition, the aerosol-generating device may automatically turn off the aerosol-generating device 100 based on the condition of the user. Thus, the age of the user can also be verified by a second method using an identity card of the user 110.

If a second user is an authorized user, such as an adult owner of the device, the aerosol-generating device may be unlocked after verifying that the user is old enough to use the aerosol-generating device. In an example, if the second user does not meet a required age for usage of the aerosol-generating device 120 estimated from a microphone measurement, for example, if the age of the user estimated from a voice of the user is below the age of the user estimated from the captured images, the aerosol-generating device may remain in a locked state and/or turn off to prevent usage from the second user, who may then be regarded as an unauthorized user.

This sequence of the operations of the image acquisition sensor and the acoustic sensor is merely provided as an example. The sequence of operations may be modified, reversed, or removed to achieve the same objective. For example, the acoustic sensor may detect the voice of the user prior to the image acquisition sensor capturing an image of the user, or the acoustic sensor may detect the sound of the user concurrently with the image detection of the user from the image acquisition sensor.

FIG. 2 is a flow diagram showing a method 200 of unlocking an aerosol-generating device. Each of the aerosol-generating device 120, the computing device 130 and the server 140 may comprise at least one processor, such that the aerosol-generating system 100 comprises at least one processor to perform at least one step of the method 200.

For example, the method 200 may be performed by an electronic device or an electronic system. The aerosol-generating system 100 described with respect to FIGS. 1A to 1C may perform the method 200. In an example, the method 200 is performed by a system, where any of the features for the aerosol-generating system described with respect to FIGS. 1A to 1C can be part of the system on which the method 200 is performed.

The method 200 comprises, in step 210, at least one captured image of a user is obtained by at least one of an aerosol-generating device, a computing device and a server. For example, the at least one captured image of the user may be obtained from the computing device, such as a mobile computing device, comprising an image acquisition sensor. The image acquisition sensor may be used to capture the at least one image of the user. The user may request to use the aerosol-generating device. For example, the user may provide an input to the aerosol-generating device or the computing device, which instructs the image acquisition sensor to capture the at least one image of the user. The image acquisition sensor may be part of the aerosol-generating device or remote from the aerosol-generating device.

In step 220, voice data of the user is obtained by at least one of the aerosol-generating device, the computing device and the server. The voice data may be obtained by measuring or capturing a sound of the user, such as the user's voice. For example, the computing device may measure a sound generated by the voice of the user for obtaining the voice data. Then the computing device may transmit the voice data to the server for further processing. The voice data may be anonymized voice data.

In step 230, the at least one image of the user is converted into at least one corresponding anonymized pixel map. This may be performed by the computing device capturing the at least one image of the user. A neural network may be used to anonymize the at least one image of the user. In step 240, the anonymized pixel map is sent to a server for estimating the age of the user. The server may process the anonymized pixel map.

In step 242, the at least one image of the user is verified to be authentic, e.g. the at least one image of the user depicts a living human. For example, verifying the at least one image of the user to be authentic may comprise determining whether the at least one image of the user has been tampered with, by analyzing the at least one image of the user using a neural network for recognizing presentation attacks. Additionally or alternatively, verifying the at least one image of the user to be authentic may comprise determining that a detected sound of the user corresponds to the at least one image of the user. Additionally or alternatively, verifying the at least one image of the user to be authentic may comprise determining a muscle movement of the user in at least two of the captured images of the user. The verification may be performed by at least one of the aerosol-generating device, the computing device and the server.

In step 250, an age of the user is estimated based on the at least one image of the user. Estimating the age of the user based on the at least one image of the user may comprise estimating the age of the user based on the anonymized pixel map at the server. The age of the user may be estimated by at least one of the aerosol-generating device, the computing device and the server. The age of the user may be estimated based on the at least one image of the user and the obtained voice data of the user. In an example, the age of the user estimated based on the at least one image of the user is verified using the obtained voice data of the user.

Step 260 comprises determining whether the estimated age of the user is above a threshold. The determination whether the estimated age of the user is above a threshold may be performed at the aerosol-generating device, the computing device or the server.

In step 270, the aerosol-generating device is unlocked for generating an aerosol from an aerosol-forming substrate when the estimated age is determined to be above the threshold. Unlocking the aerosol-generating device may comprise instructing, by the computing device, the aerosol-generating device to switch from a locked state to an unlocked state.

In step 280, the aerosol-generating device remains locked, when the estimated age is determined to be below the threshold. In the locked state, the aerosol-generating device cannot generate an aerosol from an aerosol-forming substrate

In step 290, at least one of the at least one image of the user and the anonymized pixel map is deleted after determining the estimated age of the user and/or unlocking the aerosol-generating device.

For the purpose of the present description and of the appended claims, except where otherwise indicated, all numbers expressing amounts, quantities, percentages, and so forth are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating system, comprising:
an aerosol-generating device configured to generate, in an unlocked state, an aerosol from an aerosol-forming substrate;
an image acquisition sensor configured to capture at least one image of a user of the aerosol-generating device; and
at least one processor configured to:
estimate, based on the at least one image of the user, an age of the user,
determine whether the estimated age of the user is above a threshold or equal to the threshold, and
unlock the aerosol-generating device when the estimated age is above the threshold or equal to the threshold.

17. The aerosol-generating system according to claim 16,
further comprising a microphone configured to record a voice of the user,
wherein the at least one processor is further configured to estimate the age of the user based on the at least one image of the user and the recorded voice of the user.

18. The aerosol-generating system according to claim 16,
further comprising a mobile computing device of the user,
wherein the mobile computing device comprises the image acquisition sensor.

19. The aerosol-generating system according to claim 18,
wherein the at least one processor is further configured to:
convert the at least one image of the user into at least one corresponding anonymized pixel map at the mobile computing device, and
send the anonymized pixel map from the mobile computing device to a server, and
wherein the age of the user is estimated based on the anonymized pixel map at the server.

20. The aerosol-generating system according to claim 19, wherein the at least one processor is further configured to delete at least one of the at least one image of the user and the anonymized pixel map after determining the estimated age of the user and/or unlocking the aerosol-generating device.

21. The aerosol-generating system according to claim 16, wherein the age of the user is estimated by using a machine-learning model.

22. The aerosol-generating system according to claim 16, wherein the age of the user is estimated by using a neural network.

23. The aerosol-generating system according to claim 16, wherein the at least one processor is further configured to verify that the at least one image of the user is authentic by at least one of:
determining whether the at least one image of the user has been tampered with, by analyzing the at least one image of the user using a neural network for recognizing presentation attacks,
determining that a detected sound of the user corresponds to the at least one image of the user, and
determining a muscle movement of the user in at least two of the at least one image of the user.

24. The aerosol-generating system according to claim 16, wherein the threshold is predefined.

25. The aerosol-generating system according to claim 16, wherein the threshold is predefined by a manufacturer of the aerosol-generating device.

26. The aerosol-generating system according to claim 16, wherein the threshold is at least N years above a first age set for authorizing usage of the aerosol-generating device.

27. The aerosol-generating system according to claim 26, wherein N=1 or more, 2 or more, 3 or more, 4 or more, or 5 or more.

28. The aerosol-generating system according to claim 16, wherein the at least one processor is further configured to determine a user profile of the user based on the at least one image of the user.

29. The aerosol-generating system according to claim 28, wherein the aerosol-generating device is further configured in accordance with the user profile.

30. The aerosol-generating system according to claim 16, wherein the at least one processor is further configured to verify an identity of the user based on the at least one image of the user.

31. A computer-implemented method of unlocking an aerosol-generating device, the method comprising:
obtaining at least one image of a user of an aerosol-generating device;
estimating, based on the at least one image of the user, an age of the user;
determining whether the estimated age of the user is above a threshold; and
unlocking, when the estimated age is determined to be above the threshold, the aerosol-generating device for generating an aerosol from an aerosol-forming substrate.

32. The computer-implemented method according to claim 31,
further comprising obtaining voice data of the user,
wherein the age of the user is estimated based on the at least one image of the user and the obtained voice data of the user.

33. The computer-implemented method according to claim 31, further comprising:
converting the at least one image of the user into at least one corresponding anonymized pixel map; and
send the anonymized pixel map to a server for estimating the age of the user,
wherein the age of the user is estimated based on the anonymized pixel map at the server.

34. The computer-implemented method according to claim 31, further comprising:
verifying that the at least one image of the user is authentic by at least one of:
determining whether the at least one image of the user has been tampered with, by analyzing the at least one image of the user using a neural network for recognizing presentation attacks,
determining that a detected sound of the user corresponds to the at least one image of the user, and
determining a muscle movement of the user in at least two of the at least one image of the user.
